(19) United States
(12) Patent Application Publication
(10) Pub. No.: US 2015/0096624 A1
(43) Pub. Date: Apr. 9, 2015

(54) Systems For Automatic Control Of Pump Out Of Liquid From Sumps

(71) Applicant: Bruce Larkin, Belleville, MI (US)

(72) Inventor: Bruce Larkin, Belleville, MI (US)

(21) Appl. No.: 14/045,010

(22) Filed: Oct. 3, 2013

(51) Int. Cl. B01D 29/60

(52) U.S. Cl. CPC B01D 29/605; B01D 29/606
USPC 137/2; 137/391; 210/137

(57) ABSTRACT

A system and method of controlling the rate of pump out of liquid coolant from a sump tank in which the level of liquid coolant in the sump tank is continuously sensed and corresponding signals transmitted to a variable frequency drive controller which correspondingly varies the speed of a pump motor to continuously increase or decrease the pump out rate in correspondence with the level liquid in the sump tank.

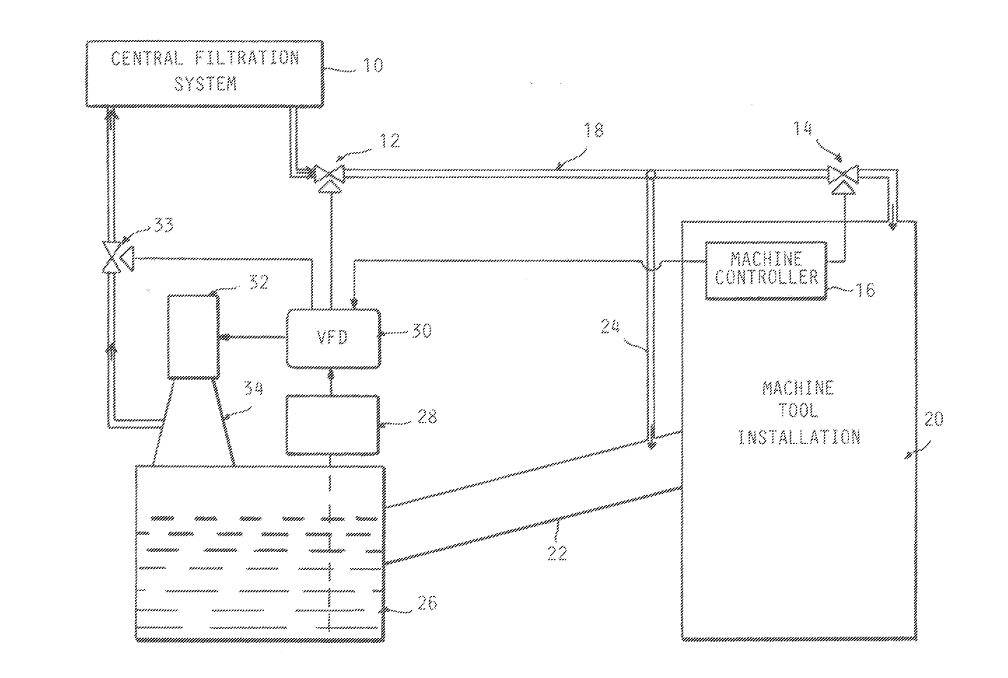

### BACKGROUND OF THE INVENTION

This invention concerns filtration systems for filtering coolant used in machine tool installation, in which filtered coolant is used in machining operations and then collected in a sump tank.

The collected dirty liquid coolant is then pumped back to a central filtration system to be filtered for reuse in the machine tool installation.

The flow of coolant varies greatly such that the operation of a pump needed to keep the sump tank from overflowing must be controlled.

The standard approach for pumping out sump tanks is to turn a pump on when an upper level is reached and turn the pump off when declining to a minimum level.

Thus this requires turning the pump motor on and off which increases the power expended and reduces the pump motor service life.

Another approach is to operate a pump at a given higher speed after a predetermined level is reached.

Sophisticated industrial controllers (PLC's) can be employed to set high and low pump speeds but are costly and may not set the correct pumping rate to prevent the sump from overflowing.

It is the object of the present invention to provide a simple but effective control over the pump rate from a sump tank which may receive inflows at substantially different rates.

### SUMMARY OF THE INVENTION

The above recited object of the invention and other objects which will be understood by those skilled in the art is achieved by the combustion of a continuous liquid level sensor associated with a sump tank with a variable frequency drive for a pump motor.

The pump motor speed is varied continuously to correspond with the sensed liquid level in the sump tank within a predetermined range. That is, the pumping rate continuously increases or decreases with increasing or decreasing sump tank liquid levels within a maximum and minimum flow rate of the pump, and shuts off at a predetermined minimum liquid level.

The sensor and variable frequency drive preferably have adjustable output and input signal ranges to allow matching of the same to eliminate the need for a PLC to reduce the costs of the system.

### DESCRIPTION OF THE DRAWING

The FIGURE is a diagram of an automatic control system for pump out of a sump tank according to the present invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawing, the present invention concerns the circulation of coolant to a machine tool installation 20. As is well known, liquid coolant is used to lubricate and cool a large number cutting tools in a typical installation.

A central filtration apparatus 10 filters the dirty liquid coolant returned from the machine tool installation, which is then directed back to the machine tool installation 20 via a coolant supply valve 12 in supply line 18 controlled by a machine supply valve 14 set to the collective demand for coolant of the various machine tools in the machine installation 20.

The coolant draining from the machine tools is collected and directed to a downward sloped chute 22. Also, a portion of the flow of clean coolant in the supply line 18 is diverted into a branch line 24 supplying a clean flushing flow to augment the discharge flow of used coolant to insure that machining chips, etc. can be carried along by the coolant flow into a sump tank 26.

According to the present invention, a liquid level sensor 28 is provided such as a commercially available pressure sensing transmitter or by an ultrasonic transmitter-sensor directing ultrasonic waves at the coolant, bath types generating signals continuously corresponding to the level of collected dirty coolant in the tank 26.

These signals are transmitted to a commercially available variable frequency drive (VFD) controller 30. The VFD controller 30 causes the motor 32 driving a pump 34 to rotate at a continuously varying speed corresponding to the level of coolant in the sump tank 26 to vary the pump out rate from the sump 26.

The VFD controller 30 and level sensor 28 are of commercially available types, which have adjustable outputs so as to be able to be directly be matched to each other. For example, a signal range of 4-20 milliamps can be set to cause the motor 32 to operate from 0 to its maximum speed in correspondence with the coolant level in the sump tank 26 over a range of liquid levels in the sump tank 26.

The low end 4 mA signal is set to be produced at a minimum level in the pump tank 26 so that no pumping occurs at the minimum sump tank level, reflecting the cessation of coolant inflow from the machine tool installation 20.

The VFD controller 32 also controls a coolant return valve 34 and valve 12 to coordinate inlet and outlet flows to and from the central filtration apparatus 10 and is itself also controlled by signals from the machine controller 16 reflecting the coolant demand of the machine tool installation 20.

The more or less continuous operation of the pump motor 32 provides better performance and service life of the pump motor 32 compared to a frequent on-off control.

The controls are simplified by the direct connection of the liquid sensor 28 and VFD controller 30 to reduce the costs of the controls and simplify the design and installation thereof.

1. In a system including a central filtration apparatus for supplying filtered coolant from a central filtration apparatus to a machine tool installation, collecting dirty used coolant, and a motor driven pump for pumping dirty coolant out of the sump tank to return dirty coolant back to said central filtration apparatus, the improvement comprising:
a liquid level sensor continuously detecting the level of dirty coolant in said sump tank, a variable frequency drive controller associated with said motor driving said pump to continuously vary the output of said pump in direct correspondence with the level of collected dirty coolant in said sump tank over a range of dirty coolant levels in said sump tank, whereby the speed of said pump motor is continuously varied in correspondence to said dirty coolant sump tank levels within said range.

2. The system according to claim 1 wherein said variable frequency drive controller directly receives signals from said dirty coolant level sensor.

3. The system according to claim 2 wherein said liquid level sensor is a pressure sensing transmitter in the sump tank.

4. A method of continuously controlling the rate of pump out of dirty coolant from a sump tank receiving coolant from a coolant using system back to a filtration apparatus, supplying clean coolant to said system comprising:
continuously sensing the level of dirty coolant in said sump tank and generating corresponding electrical signals;
transmitting said electric signals to a variable frequency drive controller;
transmitting corresponding control signals from said variable frequency drive controller to a variable speed electric motor driving a pump arranged to pump out coolant from said sump tank to continuously vary said pump drive motor speed within a range of speeds to correspond to said sensed coolant level in said drive sump thereby continuously increasing or decreasing the rate of pump out of said coolant out of said sump tank with increasing or decreasing coolant level in said sump tank within a range of coolant levels.

5. A method of controlling the rate of pump out from a sump tank which receives a varying rate of inflow of liquid from a source, comprising continuously monitoring the level of liquid in said sump tank and generating corresponding electric signals;
transmitting said control signals to a variable frequency drive controller to generate corresponding control signals;
transmitting said signals to a variable electric motor driving a pump arranged to pump liquid out of said sump tank so as to continuously vary the speed of said pump through at least a range of liquid levels in correspondence with the magnitude of said liquid level sensor signals to continuously increase or decrease the rate of pump out of liquid from said sump tank with increasing or decreasing levels of liquid in said sump tank.
